(19) United States
(12) Patent Application Publication
(10) Pub. No.: US 2012/0162425 A1
(43) Pub. Date: Jun. 28, 2012

(54) DEVICE AND METHOD FOR SECURING VISIBILITY FOR DRIVER

(75) Inventors: Sung Lok CHOI, Gyeonggi-do (KR); Won Pil YU, Ulsan (KR)

(73) Assignee: Electronics and Telecommunications Research Institute, Daejeon (KR)

(21) Appl. No.: 13/330,582

(22) Filed: Dec. 19, 2011

(30) Foreign Application Priority Data
Dec. 22, 2010 (KR) 10-2010-0132838

(51) Int. Cl. H04N 7/18; G06K 9/46; G06K 9/40

(52) U.S. Cl. 348/148; 382/275; 382/264; 382/203; 348/E07.085

(57) ABSTRACT

The device for securing visibility for a driver includes an input unit obtaining an image of an area in front of a moving object; a first estimating unit estimating from the image a geometric relationship between the moving object and its surrounding environment to output geometric relationship information; a second estimating unit estimating from the image an optical characteristic of the environment to output optical characteristic information; a first correcting unit adjusting brightness and contrast of the image based on the optical characteristic information and eliminating blob noise resulting from the environment; a second correcting unit compensating for vibration of the image based on the geometric relation information and eliminating motion blur; a synthesizing unit restoring, based on the geometric relationship information, empty space of the image resulting from the blob noise elimination and the vibration compensation and extracting and highlighting principal information of the image to acquire new image.

### CROSS-REFERENCE TO RELATED APPLICATIONS

This application claims priority to and the benefit of Korean Patent Application No. 10-2010-0132838 filed in the Korean Intellectual Property Office on Dec. 22, 2010, the entire contents of which are incorporated herein by reference.

### TECHNICAL FIELD

The present invention relates to a device and method for securing visibility for a driver using images obtained from cameras installed to a moving object such as a vehicle when conditions of outdoor environments are severe (for example, fog, rain, night time, vehicle vibration, etc.).

### BACKGROUND

For safe driving of a moving object such as a car, it is important for a driver to ensure good visibility of the surrounding environment. Meanwhile, it may be difficult for the driver to ensure good visibility for various outdoor situations through which the car runs due to a variety of factors including atmospheric factors such as rain, fog or snow, optical factors such as back light with extremely high luminance or night time with extremely low luminance, and geographical factors such as rugged roads resulting in vehicle vibration.

With conventional approaches for securing visibility for the driver, viewing angle for the driver may be enlarged using multiple cameras (including front and rear cameras) or a wide angle camera; or the driver may be informed of dangerous situations occurring while driving using a traffic line and obstacle sensing device. Such approaches may, however, be disadvantageous in that information with good driver-perceived image quality could not be provided for the driver for severe conditions of outdoor environments (for example, fog, rain, night time, vehicle vibration, etc.).

Therefore, as a conventional approach for overcoming the severe conditions of the outdoor environments, there is disclosed in Korean Patent Application Laid-Open No. 2005-0078507 a night vision apparatus for a vehicle. In the approach, when driving in fog, at night, or bad weather situations, an infrared-ray illuminator installed to a head lamp of the vehicle is used, which irradiates light with an infrared ray wavelength and then reflected infrared-ray within the viewing angle of the infrared-ray illuminator is imaged using a camera having an infrared-ray filter, resulting in providing images with high contrast. Such an approach may, however, be disadvantageous that apart from the camera, separate devices such as an infrared-ray emitting unit and an infrared-ray filter are required and, also, information with good driver-perceived image quality could not be provided for the driver during severe conditions of the outdoor environments (for example, back light, rain, vehicle vibration, etc.).

### SUMMARY OF INVENTION

The present invention has been made in an effort to provide a device and method for securing visibility for a driver which leads to clear and clean view for a driver even during severe conditions of the outdoor environments resulting from weather (rain, fog, snow), luminance (back light or night time), vehicle vibration, etc.

An exemplary embodiment of the present invention provides a device for securing visibility for a driver, including: an input unit obtaining an image of an area in front of a moving object driven by the driver; a first estimating unit estimating from the image a geometric relationship between the moving object and an environment surrounding the moving object to output geometric relationship information; a second estimating unit estimating from the image an optical characteristic of the environment to output optical characteristic information; a first correcting unit adjusting brightness and contrast of the image based on the optical characteristic information and eliminating blob noise resulting from the environment including snow or rain; a second correcting unit compensating for vibration of the image based on the geometric relationship information and eliminating motion blur; a synthesizing unit restoring, based on the geometric relationship information, empty space of the image resulting from the blob noise elimination by the first correcting unit and the vibration compensation by the second correcting unit, and extracting and highlighting principal information of the image to acquire a new image; and an output unit providing the new image for the driver.

Another exemplary embodiment of the present invention provides a method for securing visibility for a driver, including: (a) obtaining an image of an area in front of a moving object driven by the driver; (b) estimating from the image a geometric relationship between the moving object and an environment surrounding the moving object to output geometric relationship information; (c) estimating from the image an optical characteristic of the environment to output optical characteristic information; (d) adjusting brightness and contrast of the image based on the optical characteristic information and eliminating blob noise resulting from the environment including snow or rain; (e) compensating for vibration of the image based on the geometric relationship information and eliminating motion blur; and (f) restoring, based on the geometric relationship information, empty space of the image resulting from the blob noise elimination and the vibration compensation, and extracting and highlighting principal information of the image to acquire new image, and providing the new image for the driver.

According to exemplary embodiments of the present invention, it is possible to provide to the driver clear and clean images of driving areas that are not influenced by the outdoor factors (for example, fog, rain, night time, vehicle vibration, etc) by processing/synthesizing the image obtained from a camera of the moving object running during severe conditions of outdoor situations, so that the driver may secure improved visual ability and thus safely manipulate the moving object.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram of a device for securing visibility for a driver according to an exemplary embodiment of the invention.

FIG. 2A shows an example of an image input into a device for securing visibility for a driver according to an exemplary embodiment of the invention, and FIG. 2B shows an example of a new image output from the device for securing visibility for a driver according to an exemplary embodiment of the invention and provided to the driver.

FIG. 3 is a flow chart of a method for securing visibility for a driver according to an exemplary embodiment of the invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the FIGures, reference numbers refer to the same or equivalent parts of the present invention throughout the several FIGures of the drawing.

### DETAILED DESCRIPTION

Hereinafter, exemplary embodiments of the present invention will be described in detail with reference to the accompanying drawings.

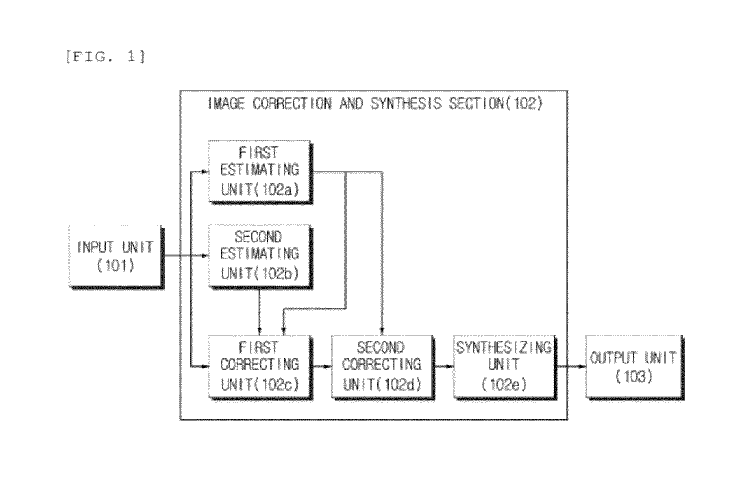

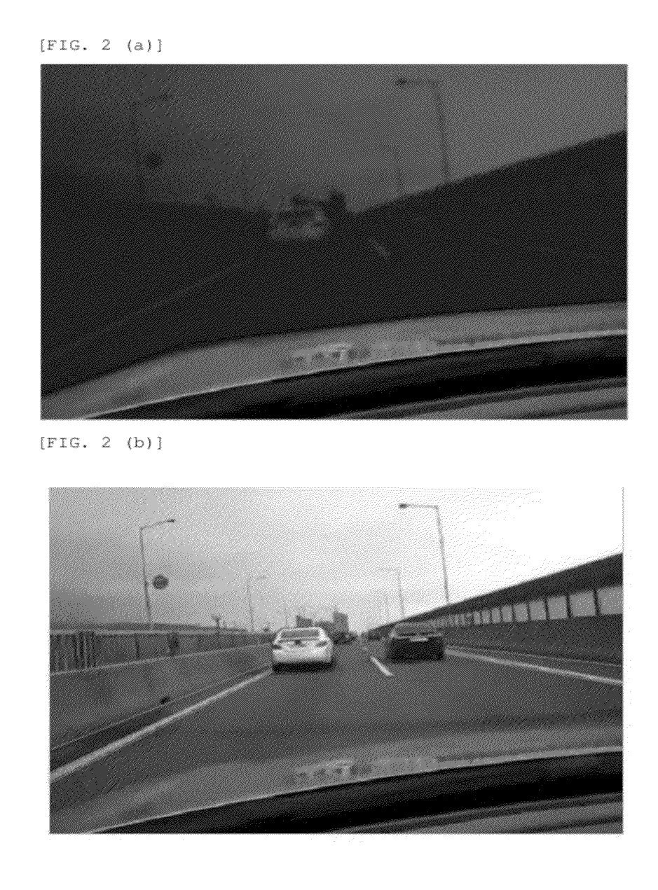

First, a device for securing visibility of a driver according to an exemplary embodiment of the invention will be described with reference to FIG. 1 and FIG. 2.

Referring to FIG. 1, the device for securing visibility for a driver according to the exemplary embodiment of the invention may include an input unit 101 obtaining an image of an area in front of a moving object driven by the driver; a first estimating unit 102a estimating from the image a geometric relationship between the moving object and an environment surrounding the moving object to output geometric relationship information; a second estimating unit 102b estimating from the image an optical characteristic of the environment to output optical characteristic information; a first correcting unit 102c adjusting brightness and contrast of the image based on the optical characteristic information and eliminating blob noise resulting from the environment including snow or rain; a second correcting unit 102d compensating for vibration of the image based on the geometric relationship information and eliminating motion blur; a synthesizing unit 102e restoring, based on the geometric relationship information, empty space of the image resulting from the blob noise elimination by the first correcting unit 102c and the vibration compensation by the second correcting unit 102d, and extracting and highlighting principal information of the image to acquire new image; and an output unit 103 providing the new image for the driver.

Each of the components of the driver's visibility securing device according to an exemplary embodiment of the invention will be described as follows.

Referring to FIG. 1, the input unit 101 may obtain an image of an area in front of a moving object (e.g. a vehicle) driven by the driver and one example thereof may be a camera.

With the driver's visibility securing device according to the exemplary embodiment of the invention, the image in front of the moving object, as one example, is obtained using the input unit 101. However, the invention is not limited thereto but, rather, images at the rear or side of the moving object, in addition to or as an alternative to the image in front of the moving object, may be captured using the camera. Further, in regards to the imaging, various images may be obtained using the camera without departing from the intention of the invention.

The first estimating unit 102a may estimate from the image a geometric relationship between the moving object manipulated by the user and an environment surrounding the moving object to output geometric relationship information.

The geometric relationship information may include information on relative movement amount of a current image to a previous image. The movement amount may also be defined as relative movement amount of the camera or relative movement amount of the moving object.

Here, there may be one example of the way in which the first estimating unit 102a estimates the relative movement amount of the current image based on or to the previous image. That is, first, determined are feature points (e.g. an edge of a given object) specified in the previous image obtained at a past time (t-1) and in the current image obtained at a current time (t), and then the identical feature points are linked or matched with each other, and by analyzing the movement of the matched feature points, the relative movement amount of the current image to the previous image may be estimated.

The geometric relationship information may include information on relative positions of pixels in the image to the moving object.

Here, there may be one example of how to estimate the relative positions of pixels in the image to the moving object. For example, the image is converted into a top-view image and then relative positions of given objects in the converted image to the moving object are calculated.

The second estimating unit 102b may estimate from the image an optical characteristic of the environment to output optical characteristic information.

The optical characteristic information may include values of parameters belonging to an optical model with fog, back light or night time in the environment.

The first correcting unit 102c may adjust brightness and contrast of the image based on the optical characteristic information estimated from the second estimating unit 102b and eliminate blob noise resulting from the environment including snow or rain.

The first correcting unit 102c may eliminate the blob noise resulting from the snow or rain falling from the sky to the ground by extracting, from the image, components with high frequency characteristics in terms of time and space and then removing the extracted components.

Meanwhile, in order to eliminate the blob noise resulting from droplets or snowflakes attached and fixed to a lens of the camera as one example of the input unit 101, the first correcting unit 102c identifies portions of the image with the same movement as that of a moving object based on information on relative movement amount of the moving object included in the geometric relationship information from the first estimating unit 102a and then remove the identified portions from the image.

The second correcting unit 102d may compensate for vibration of the image based on the geometric relationship information from the first estimating unit 102a and eliminate motion blur.

The second correcting unit 102d compensates for vibration of the image by extracting high frequency movement corresponding to the vibration from the information on relative movement amount of the moving object included in the geometric relationship information from the first estimating unit 102a and applying the extracted high frequency movement to the image in a reverse manner.

The second correcting unit 102d removes the motion blur by estimating the motion blur model causing the motion blur, and calculating, based on the motion blur model, pixel values without vibration, and replacing image pixel values with the calculated pixel values.

The synthesizing unit 102e may restore, based on the geometric relationship information from the first estimating unit 102a, empty space of the image resulting from the blob noise elimination by the first correcting unit 102c and the vibration compensation by the second correcting unit 102d, and may extract and highlight contour lines in the image or divide the image and highlight faces of the divided images to acquire a new image in which principal information thereof is highlighted.

The synthesizing unit 102e restores the empty space of the image resulting from the blob noise elimination by the first correcting unit 102c and the vibration compensation by the second correcting unit 102d by estimating pixel values of the empty space based on tendency of values of the pixels around the empty space and applying the estimated pixel values to the empty space. Alternatively, the synthesizing unit 102e restores the empty space by determining regions, among the previous image, to be filled into an empty space of a current image based on information on change regarding a relative position of the moving object included in the geometric relationship information from the first estimating unit 102a and fill the determined regions into the empty space of the current image.

When extracting and highlighting contour lines in the image or dividing the image and highlighting faces of the divided images to acquire a new image in which principal information thereof is highlighted, the synthesizing unit 102e determines, based on information on change regarding a relative position of the moving object included in the geometric relationship information from the first estimating unit 102a, which areas within the current image at which the contour line or divided image information of the previous image is to appear and thereafter uses prior probability based on the determining.

The output unit 103 provides the driver with the acquired new image output from the synthesizing unit 102e. The output unit 103 may, as an example, include a transparent display device installed to a front glass of the moving object (e.g., a car), a separate terminal for displaying images or a display device connected to a computer at a control center with a remote operator.

FIG. 2A shows an example of an image input to the input unit 101 during a foggy outdoor environment, and FIG. 2b shows, when employing as the output unit 103 the transparent display device installed to a front glass of the moving object, an example of an image provided to the driver through the unit 103 after the image of FIG. 2a is subject to the processes and changed to the new image by the first and second estimating units 102a and 102b, first and second correcting units 102c and 102d and a synthesizing unit 102e according to the exemplary embodiments of the invention.

From FIG. 2A and FIG. 2B, it may be recognized that it is possible for the device in accordance with the exemplary embodiment to provide to the driver who drives the vehicle through the severe outdoor conditions clear and clean images of driving areas which are not influenced by the severe outdoor factors so that the driver may secure improved visual ability or driving visibility and thus safely manipulate the moving object.

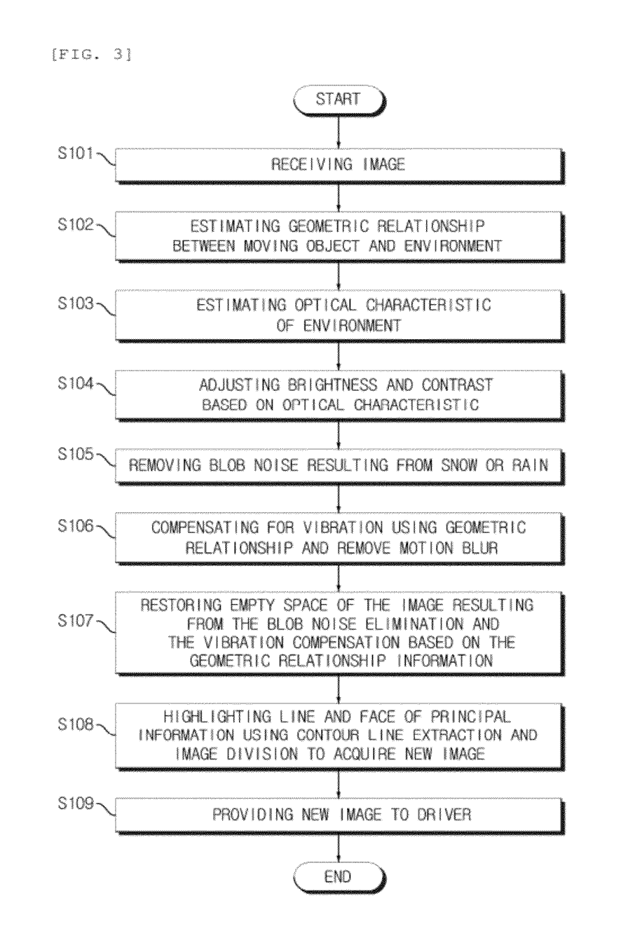

Next, a method for securing visibility for a driver according to an exemplary embodiment of the invention will be described with reference to FIG. 3.

At the beginning, the input unit 101 may obtain an image of an area in front of a moving object (e.g. a vehicle) driven by the driver (S101). In this case, images at a rear or side of the moving object, in addition to or as an alternative to the image in front of the moving object, may be input to the input unit 101.

Thereafter, the first estimating unit 102a may estimate from the image a geometric relationship between the moving object and an environment surrounding the moving object to output geometric relationship information (S102).

The geometric relationship information may include information on relative movement amount of a current image to a previous image. The movement amount may also be defined as relative movement amount of the camera or relative movement amount of the moving object.

Here, there may be one example of the way in which the first estimating unit 102a estimates the relative movement amount of the current image based on or to the previous image. For example, first, determined are feature points (e.g. an edge of a given object) specified in the previous image obtained at a past time (t-1) and in the current image obtained at a current time (t). Next, the identical or similar feature points are linked or matched with each other, and, then, with analysis of the movement of the matched feature points, the relative movement amount of the current image to the previous image may be estimated.

The geometric relationship information may include information on relative positions of pixels in the image to the moving object.

Here, there may be one example of how to estimate the relative positions of pixels in the image to the moving object. That it, the image is converted into a top-view image and then relative positions of given objects in the converted image to the moving object are calculated.

Next, the second estimating unit 102b may estimate from the image an optical characteristic of the environment to output optical characteristic information (S103).

The optical characteristic information may include values of parameters belonging to an optical model with fog, back light or night time in the environment.

Subsequently, the first correcting unit 102c may adjust brightness and contrast of the image based on the optical characteristic information from the second estimating unit 102b (S104) and eliminate blob noise resulting from the environment including snow or rain (S105).

The first correcting unit 102c may eliminate the blob noise resulting from the snow or rain falling from the sky by extracting, from the image, components with high frequency characteristics in terms of time and space and then removing the extracted components.

Meanwhile, in order to eliminate the blob noise resulting from droplets or snowflakes attached and fixed to a lens of the camera as one example of the input unit 101, the first correcting unit 102c identifies portions of the image with the same movement as that of moving object based on information on relative movement amount of the moving object included in the geometric relationship information from the first estimating unit 102a and then removes the identified portions from the image.

At a following step, the second correcting unit 102d may compensate for vibration of the image based on the geometric relationship information from the first estimating unit 102a and eliminate motion blur (S106).

Here, the second correcting unit 102d compensates for vibration of the image by extracting high frequency movement corresponding to the vibration from the information on relative movement amount of the moving object included in the geometric relationship information from the first estimating unit 102a and applying the extracted high frequency movement to the image in a reverse manner.

The second correcting unit 102d removes the motion blur by estimating the motion blur model causing the motion blur, and calculating, based on the motion blur model, pixel values without vibration, and replacing image pixel values with the calculated pixel values.

Nest, the synthesizing unit 102e may restore, based on the geometric relationship information from the first estimating unit 102a, empty space of the image resulting from the blob noise elimination by the first correcting unit 102c and the vibration compensation by the second correcting unit 102d (S107). The synthesizing unit 102e may extract and highlight contour lines in the image or divide the image and highlight faces of the divided images to acquire a new image in which principal information thereof is highlighted (S108).

Here, the synthesizing unit 102e restores the empty space of the image resulting from the blob noise elimination by the first correcting unit 102c and the vibration compensation by the second correcting unit 102d by estimating pixel values of the empty space based on tendency of values of the pixels around the empty space and applying the estimated pixel values to the empty space. Otherwise, the synthesizing unit 102e may restore the empty space by determining regions, among the previous image, to be filled into an empty space of a current image based on information on change in a relative position of the moving object included in the geometric relationship information estimated from the first estimating unit 102a and fill the determined regions into the empty space of the current image.

When extracting and highlighting contour lines in the image or dividing the image and highlighting faces of the divided images to acquire a new image in which principal information thereof is highlighted, the synthesizing unit 102e calculates, based on information on change in a relative position of the moving object included in the geometric relationship information estimated from the first estimating unit 102a, which areas within the current image at which the contour line or divided image information of the previous image is to appear and thereafter uses prior probability.

Finally, the output unit 103 provides the driver with the acquired new image output from the synthesizing unit 102e (S109). Here, the unit 103 may, as an example, include a transparent display device installed to a front glass of the moving object (e.g. a car), a separate terminal for displaying images or a display device connected to a computer at a control center with a remote operator.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects o f the present invention are not limited by the particular de tails of the examples illustrated herein, and it is therefor e contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A device for securing visibility for a driver, comprising:
an input unit obtaining an image in front of a moving object driven by the driver;
a first estimating unit estimating from the image a geometric relationship between the moving object and an environment surrounding the moving object to output geometric relationship information;
a second estimating unit estimating from the image an optical characteristic of the environment to output optical characteristic information;
a first correcting unit adjusting brightness and contrast of the image based on the optical characteristic information and eliminating blob noise resulting from the environment including snow or rain;
a second correcting unit compensating for vibration of the image based on the geometric relationship information and eliminating motion blur;
a synthesizing unit restoring, based on the geometric relationship information, empty space of the image resulting from the blob noise elimination by the first correcting unit and the vibration compensation by the second correcting unit, and extracting and highlighting principal information of the image to acquire a new image; and
an output unit providing the new image for the driver.

2. The device of claim 1, wherein the geometric relationship information includes information on relative movement amount of a current image to a previous image and information on relative positions of pixels in the image to the moving object.

3. The device of claim 1, wherein the optical characteristic information includes values of parameters belonging to an optical model with fog, back light or nigh time in the environment.

4. The device of claim 1, wherein the first correcting unit eliminates the blob noise resulting from snow or rain falling from sky by extracting, from the image, components with high frequency characteristics in terms of time and space and then removing the extracted components.

5. The device of claim 1, wherein the first correcting unit eliminates the blob noise resulting from droplets or snowflakes formed in the image in a fixed way by identifying, based on information on relative movement amount of the moving object included in the geometric relationship information input from the first estimating unit, portions of the image with the same movement as that of moving object and then removing the identified portions from the image.

6. The device of claim 1, wherein the second correcting unit compensates for the vibration of the image by extracting high frequency movement corresponding to the vibration from the information on relative movement amount of the moving object included in the geometric relationship information from the first estimating unit and applying the extracted high frequency movement to the image in a reverse manner.

7. The device of claim 1, wherein the second correcting unit removes the motion blur by estimating motion blur model causing the motion blur, and calculating, based on the motion blur model, pixel values without vibration, and replacing image pixel values with the calculated pixel values.

8. The device of claim 1, wherein the synthesizing unit restores the empty space of the image by estimating pixel values of the empty space based on tendency of values of the pixels around the empty space.

9. The device of claim 1, wherein the synthesizing unit restores the empty space of the image by determining regions, among the previous image, to be filled into an empty space of a current image base on information on change in a relative position of the moving object included in the geometric relationship information input from the first estimating unit.

10. The device of claim 1, wherein the synthesizing unit extracts and highlights contour lines in the image or divides the image and highlights faces of the divided images to acquire a new image in which principal information thereof is highlighted; and
wherein the synthesizing unit determines, based on information on change in a relative position of the moving object included in the geometric relationship information input from the first estimating unit, which areas within the current image at which the contour line or divided image information of the previous image is to appear and thereafter uses prior probability in performing the contour extraction and image division on the current image.

11. A method for securing visibility for a driver manipulating a moving object, comprising:
(a) obtaining an image in front of a moving object driven by the driver;
(b) estimating from the image a geometric relationship between the moving object and an environment surrounding the moving object to output geometric relation information;
(C) estimating from the image an optical characteristic of the environment to output optical characteristic information;
(d) adjusting brightness and contrast of the image based on the optical characteristic information and eliminating blob noise resulting from the environment including snow or rain;
(e) compensating for vibration of the image based on the geometric relationship information and eliminating motion blur; and
(f) restoring, based on the geometric relationship information, empty space of the image resulting from the blob noise elimination and the vibration compensation, and extracting and highlighting principal information of the image to acquire a new image, and providing the new image for the driver.

12. The method of claim 11, wherein at step (b), the geometric relationship information includes information on relative movement amount of a current image to a previous image and information on relative positions of pixels in the image to the moving object.

13. The method of claim 11, wherein at step (c), the optical characteristic information includes values of parameters belonging to an optical model with fog, back light or nighttime in the environment.

14. The method of claim 11, wherein step (d) comprises eliminating the blob noise resulting from snow or rain falling from the sky by extracting, from the image, components with high frequency characteristics in terms of time and space and then removing the extracted components.

15. The method of claim 11, wherein step (d) comprises eliminating the blob noise resulting from droplets or snowflakes formed in the image in a fixed way by identifying portions of the image with the same movement as that of moving object based on information on relative movement amount of the moving object included in the geometric relationship information and removing the identified portions from the image.

16. The method of claim 11, wherein step (e) comprises compensating for the vibration of the image by extracting high frequency movement corresponding to the vibration from the information on relative movement amount of the moving object included in the geometric relationship information and applying the extracted high frequency movement to the image in a reverse manner.

17. The method of claim 11, wherein step (e) comprises removing the motion blur by estimating motion blur model causing the motion blur, and calculating, based on the motion blur model, pixel values without vibration, and replacing image pixel values with the calculated pixel values.

18. The method of claim 11, wherein step (f) comprises restoring the empty space of the image resulting from the blob noise elimination and the vibration compensation by estimating pixel values of the empty space based on tendency of values of the pixels around the empty space.

19. The method of claim 11, wherein step (f) comprises restoring the empty space of the image by determining regions, among the previous image, to be filled into an empty space of a current image base on information on change in a relative position of the moving object included in the geometric relationship information.

20. The method of claim 11, wherein step (f) comprises extracting and highlighting contour lines in the image or dividing the image and highlighting faces of the divided images to acquire a new image in which principal information thereof is highlighted; and
wherein step (f) comprises determining, based on information on change in a relative position of the moving object included in the geometric relationship information, which areas within the current image at which the contour line or divided image information of the previous image is to appear and thereafter uses prior probability in performing the contour extraction and image division on the current image.
